(19) United States
(12) Patent Application Publication
(10) Pub. No.: US 2007/0071649 A1
(43) Pub. Date: Mar. 29, 2007

(54) Capillary-channeled polymer fibers as stationary phase media for spectroscopic analysis

(76) Inventor: R. Kenneth Marcus, Seneca, SC (US)

Correspondence Address: LEIGH P. GREGORY;ATTORNEY AT LAW, PO BOX 168, CLEMSON, SC, 29633-0168, US

(21) Appl. No.: 11/546,602

(22) Filed: Oct. 12, 2006

Related U.S. Application Data
(63) Continuation-in-part of application No. 10/485,701, filed on Feb. 3, 2004.
(60) Provisional application No. 60/318,533, filed on Sep. 10, 2001.

(51) Int. Cl. G01N 21/00

(52) U.S. Cl. 422/82.11

(57) ABSTRACT

Surface-channeled fibers, either single fibers or a plurality of fibers, and surface-channeled films are useful in a variety of on-column detection systems, both those requiring detection by a spectroscopic detector and those for which a chemically selective indicator provides a visually distinguishable response.

### CROSS-REFERENCE TO RELATED APPLICATIONS

The present application is a continuation-in-part of U.S. Ser. No. 10/485,701, filed Feb. 3, 2004, which claims priority to PCT International Application Ser. No. PCT/US02/25576, filed Aug. 13, 2002, which claimed the benefit of prior provisional application Ser. No. 60/318,533, filed Sep. 10, 2001.

### FIELD OF THE INVENTION

The present invention relates to chemical analysis of species in solution and more particularly to liquid chromatography and clinical diagnostics.

### BACKGROUND OF THE INVENTION

At present, liquid-phase chemical separations are usually performed in “columns” prepared by the packing of metal tubes with spherical beads that are composed of either silica or polystyrene and have diameters of 3 to 50 μm. The more or less inert beads provide solid supports that are chemically modified to produce a surface having targeted chemical characteristics. For example, in performing reversed-phase liquid chromatography, long carbon chains (C-18) can be affixed to the surfaces of the beads so as to produce a hydrophobic surface for the separation of non-polar organics. In these systems the surfaces of the silica beads serve as the support for the long carbon chain stationary phase. However, in some systems post-formation modification of the beads is not required. For these systems the beads themselves are the stationary phase.

Effective separations require dense packing of the beads into these columns to avoid dead-volume, which is any location within the column where turbulence can occur and interactions between molecules in the liquid and the surfaces of the beads are minimal. As a consequence of dense packing, high driving pressures (e.g., 2,000 to 5,000 psi) are required to overcome the backpressures that otherwise would prevent the liquid phase from moving through the densely packed columns.

Alternatively, highly porous “monoliths” are formed within the columns to generate high surface areas for interaction with the species that flow through the columns. Here, a limited set of stationary phase chemistries and column-to-column reproducibility can be restrictive. In the case of so-called “prep-scale” separations, the capital costs associated with producing large volume columns and the demands on the system hydraulics (i.e. pumps) are very high.

More recently, the above-referenced parent application teaches the use of channeled polymer fibers as stationary phases for chemical separation by liquid chromatography and subsequent spectroscopic analysis. Although addressing many of the problems of the prior art, spectroscopic detection in the parent application is limited to post-column analysis, i.e., after chromatographic separation.

### SUMMARY OF THE INVENTION

Accordingly, the present invention is directed to on-column, more specifically on-fiber, spectroscopic detection and systems for conducting such.

Thus, in one aspect the present invention is directed to an apparatus, including a fluid conduit having a first end and a second end disposed opposite the first end, a plurality of polymer fibers disposed within the conduit, extending between the first end and the second end, a probing position defined at a location along the conduit between the first end and the second end of the conduit, and a spectroscopic detector in alignment with the probing position and configured for detecting solute species in a fluid moving through the conduit and along the length of the polymer fibers.

In one embodiment, each of the polymer fibers is configured with a plurality of co-linear channels along the entire length of the surface of each fiber. The present apparatus also may include a device for moving fluid through the conduit, the device being connected to the first end of the conduit. In one embodiment the polymeric composition of the polymer fibers inherently attracts and retains specific solute species. However, it is also within the scope of the present invention that the polymer fibers have been modified to exhibit enhanced reactivity toward specific solute species or to exhibit attraction and binding for a specific solute species.

In another aspect the present invention is directed to an apparatus, including a fluid conduit having a first end and a second end disposed opposite the first end, a polymer fiber disposed within the conduit, extending between the first end and the second end, the fiber having a plurality of co-linear channels along the entire length of the surface thereof, a probing position defined at a location along the conduit between the first end and the second end of the conduit, and a spectroscopic detector in alignment with the probing position and configured for detecting solute species in a fluid moving through the conduit and along the length of the polymer fiber. Preferably, the step of detecting the solute species is achieved by a detection method selected from IR absorbance, UV-VIS absorbance, fluorescence, Raman spectroscopy, and mass spectrometry.

Thus, in one embodiment the fluid is pumped through the capillary channels. However, it is also within the scope of the present invention that the fluid is moved through the capillary channels by wicking action or that the fluid is moved through the capillary channels via electro-osmosis. In one embodiment the conduit has a single polymer fiber positioned therein, the capillary channels being formed by a plurality of co-linear channels configured along the entire length of the surface of the polymer fiber. Alternatively, the conduit has a plurality of polymer fibers aligned therein, which fibers may be configured with a plurality of co-linear channels along the entire length of the surface of each fiber. In one embodiment at least a portion of the plurality of polymers are bonded to adjacent fibers.

In a still further aspect the present invention is directed to a device for visually detecting at least one solute species in a fluid, which includes at least one polymer fiber, the at least one polymer fiber defining a plurality of capillary channels capable of wicking a fluid, and at least one chemically selective indicator disposed on the surface of the at least one polymer fiber, the chemically selective indicator exhibiting a visually distinguishable response in the presence of the at least one solute species.

Thus, in one embodiment the at least one polymer fiber is a single polymer fiber, the capillary channels being formed by a plurality of co-linear channels configured along the entire length of the surface of the single polymer fiber. Alternatively, the at least one polymer fiber may be a plurality of polymer fibers and each or some may be configured with a plurality of co-linear channels along the entire length of the surface thereof. Optionally, at least portions of the plurality of polymer fibers are bonded to adjacent fibers.

Also, in one embodiment the at least one chemically selective indicator may include at least a first chemically selective indicator and a second chemically selective indicator for detecting at least two differing solute species. For such embodiment the first chemically selective indicator may be disposed on the surface of the at least one polymer fiber at a desired interval from the disposition of the second chemically selective indicator. Alternatively, the first chemically selective indicator and the second chemically selective indicator may be essentially adjacent to each other in separate channels and at essentially the same position along the length of the at least one polymer fiber.

In yet another aspect the present invention is directed to a method for detecting at least one solute species in a fluid, which includes the steps of providing at least one polymer fiber having a first end and a second, the at least one polymer fiber defining a plurality of capillary channels capable of wicking a fluid, disposing on the surface of the at least one polymer fiber at least one chemically selective indicator, the chemically selective indicator being capable of exhibiting a visually distinguishable response in the presence of the at least one solute species, exposing the first end of the at least one polymer fiber to a fluid, and observing the at least one polymer fiber to determine the presence of a visually distinguishable response indicating the presence of the at least one solute species. Preferably, the visually distinguishable response exhibited by the chemically selective indicator comprises a color change.

In one embodiment the at least one polymer fiber is a single polymer fiber, the capillary channels being formed by a plurality of co-linear channels configured along the entire length of the surface of the polymer fiber. Alternatively, the at least one polymer fiber may be a plurality of polymer fibers and each or some may be configured with a plurality of co-linear channels along the entire length of the surface thereof. Optionally, at least portions of the plurality of polymer fibers are bonded to adjacent fibers.

Also, in one embodiment the at least one chemically selective indicator may include at least a first chemically selective indicator and a second chemically selective indicator for detecting at least two differing solute species. For such embodiment the step of disposing at least one chemically selective indicator on the surface of the at least one polymer may involve disposing the first chemically selective indicator on the surface of the at least one polymer fiber and disposing the second chemically selective indicator on the surface of the at least one polymer fiber at a desired interval from the first chemically selective indicator. Alternatively, the step of disposing at least one chemically selective indicator on the surface of the at least one polymer fiber may involve disposing the first chemically selective indicator and the second chemically selective indicator essentially adjacent to each other and at essentially the same position along the length of the at least one polymer fiber.

In a still further aspect the present invention is directed to a method for detecting at least one solute species in a fluid, which includes the steps of providing at least one polymer fiber having a first end and a second, the at least one polymer fiber defining a plurality of capillary channels capable of wicking a fluid, exposing the first end of the at least one polymer fiber to a fluid containing the at least one solute species such that the fluid wicks onto the at least one polymer fiber, separating the at least one species from the fluid by chemical attachment of the species to the at least one polymer fiber, positioning the at least one polymer fiber in an instrument configured for detecting the at least one solute species, and detecting the at least one species on the at least one polymer fiber with the instrument. Preferably, the step of detecting the at least one species is achieved by a detection method selected from IR absorbance, UV-VIS absorbance, fluorescence, Raman spectroscopy, and mass spectrometry, although other detection methods are within the scope of the present invention.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, in which:

FIG. 1 is a cross-sectional representation of a liquid analyte flowing through channeled fibers placed in a single column formed by a 0.25-inch (about 4.5 mm) diameter tube, including an expanded view window showing the end-on shape of the fibers and the potential irregular packing of the fibers in the column.

FIG. 2A is a scanning electron micrograph of an enlarged side view of an intermediate portion of a channeled polyester fiber such as may be used in a column of a chromatograph.

FIG. 2B is a micrograph of enlarged side views of end portions of two channeled polyester fibers such as can be used in a column of a chromatograph.

FIG. 3A is a micrograph of an enlarged cross-section of a surface channeled film in accordance with the present invention, well suited for lateral flow assay applications.

FIG. 3B is a micrograph of an enlarged side view of a surface channeled film as shown in FIG. 3A.

FIG. 4A is a schematic representation of a separation apparatus in accordance with the present invention.

FIG. 4B is a schematic representation of a spectroscopic detector aligned with a probing position on the column of FIG. 4A.

FIG. 5 is a schematic representation of a capillary electrophoresis system in accordance with the present invention.

FIG. 6 is a perspective view of a lab on a chip capable of carrying a single surface-channeled fiber in accordance with the present invention.

FIG. 7 schematically represents the use of a fiber/film assembly used to sample an analyte-containing liquid for subsequent transport to a separate instrument having an appropriate detector for analysis of immobilized solutes in accordance with the present invention.

FIG. 8 illustrates a single surface-channeled fiber surface modified with three chemically selective indicators for detecting the presence of two solute species.

FIG. 9 is a schematic representation of a lateral flow assay system employing a plurality of chemically selective indicators in accordance with the present invention.

### DETAILED DESCRIPTION

Reference will now be made in detail to various embodiments of the invention, one or more examples of which are illustrated in the accompanying drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents.

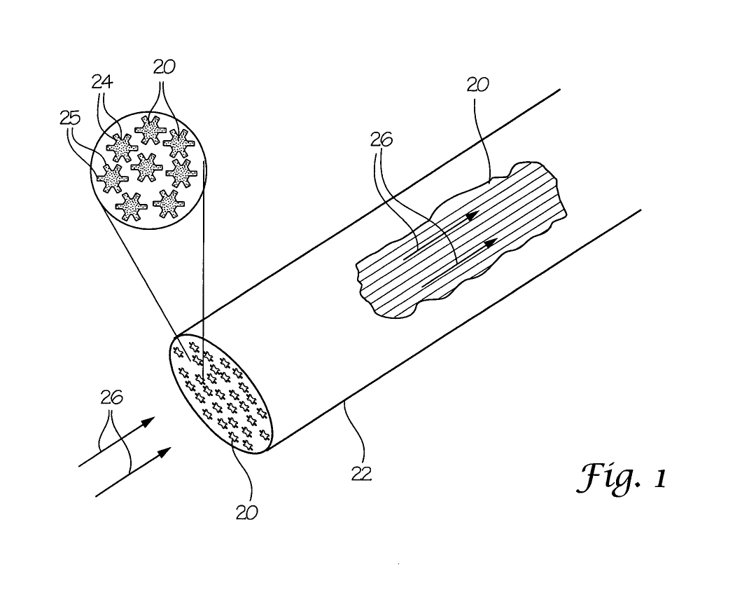

As shown in FIG. 1, bundles of surface-channeled polymer fibers 20 are packed into a column 22 that is formed by a tube having a uniform circular inside diameter of 0.25 inches and a length of 12 inches. The dimensions of the column 22 can be any size that is used in the practice of chromatography. Desirably, the length of each fiber 20 is substantially the same as the length of the column 22 and is disposed to extend within the column 22 over substantially the entire length of the column 22. However, fibers 20 that have lengths that are shorter than the length of the column 22 may be used, but are not preferred. Moreover, an individual column can include fibers of various lengths.

FIG. 1 also includes an inset that illustrates one possible embodiment of the surface-channel fibers. As shown schematically in cross-section in the expanded view of the inset, each fiber strand 20 has six co-linear channels 24 extending the entire length of the exterior surface of the fiber 20. Each channel 24 is defined by a pair of opposed walls 25 that extend generally and longitudinally and form part of the exterior surface of the fiber 20. Desirably, these channels 24 and walls 25 extend down the entire length of the fiber 20 parallel to the longitudinal axis of the fiber 20 and are nominally co-linear on each fiber 20. This produces defacto substantially the same co-linear channels 24 along the entire length of the column 22. It should be understood that the particular shape of the embodiment of the surface-channeled fibers illustrated in FIG. 1 is not a requirement of the present invention. For instance, the number and/or cross-sectional shape of the channels can vary from that shown in the figures.

Additionally, in the course of packing the fibers 20 into a bundle that lies along the entire length of the column 22, it is possible that one or more, even all, of the fibers 20 in the bundle will rotate about its/their own axis or the axis of the column 22 over the entire length of the column. In other words, the surface-channeled fibers 20 may twist as they lay from one end of the column 22 to the opposite end. Accordingly, the channels 24 and walls 25 also may twist somewhat.

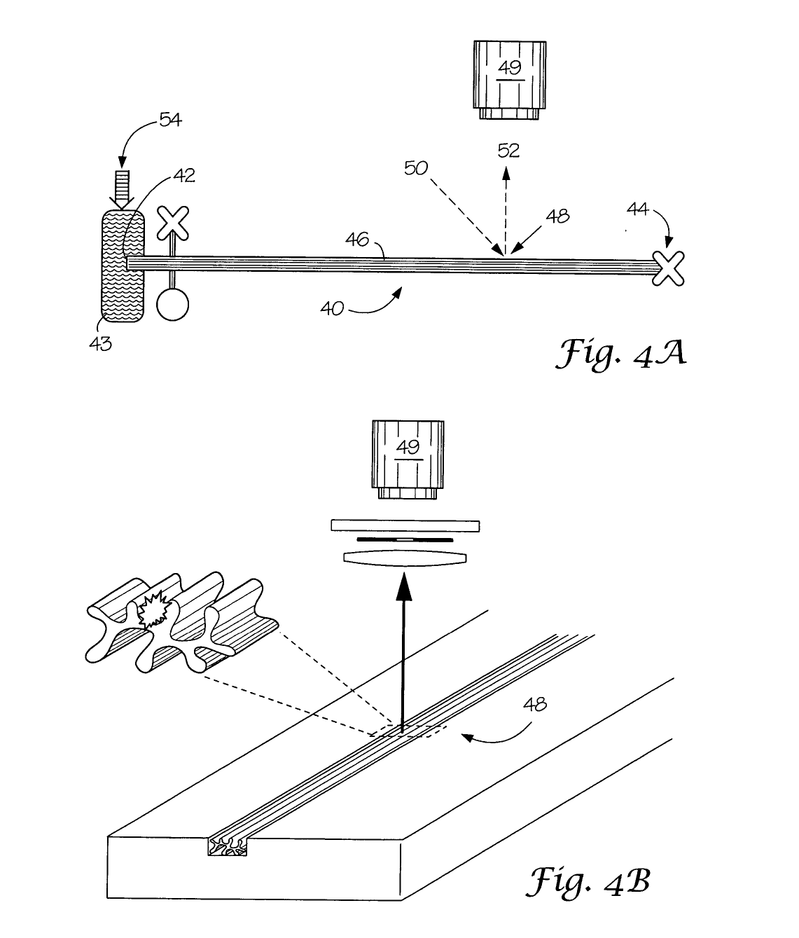

In some embodiments of the present invention, a device can be provided to move fluid through the column 22 and thus through the channels 24 of the fibers 20. A pump (not shown in FIG. 1 but represented in FIG. 4A) is typically provided for this purpose. The flow of liquid through the column 22 is schematically indicated by the arrows designated by the numeral 26 in FIG. 1. A portion of the column 22 is cut away in the view shown in FIG. 1 for the purpose of illustrating the flow of liquid 26 through the column 22 along the fibers 20 arranged with their longitudinal axes parallel to the longitudinal axis of the column 22. The nominal diameter of each fiber 20 desirably ranges 10 to 80 micrometers.

In general, any method for moving the fluid through the column 22 as is generally known in the art may be utilized. For example, in other embodiments, electro-osmosis or any other suitable hydro-dynamic means may be utilized to move fluid through the column 22.

However, in some applications, the movement of the fluid may be effected without a device that is separate from the fibers themselves. In such embodiments, the fluid can, in one embodiment, move through the channels 24 of the fibers 20 solely by capillary action of the channels 24 of the fibers 20. In other embodiments of the invention, discussed in detail below, the fluid can move through the column with macro-level capillary action between the fibers in addition to or alternative to the micro-level capillary action through the channels 24 of the individual fibers 20.

Advantageous in the use of these channeled polymer fibers 20 as stationary phase materials, as compared to fibers having a more circular cross-sectional shape, is their higher surface area-to-volume ratios. Moreover, the shape and the number of channels 24 can be dependent on achieving the desired attribute of very high surface area-to-volume ratios.

Another advantage of using channeled polymer fibers 20 in the disclosed processes is the fact that they generate very low backpressures (e.g., 500 to 1500 psi for linear channels 24 for normal chromatography flow rates (0.5 to 3 mL/min)). The lower backpressure produced in the column 22 containing channeled polymer fibers 20 relative to the backpressure produced in the conventional column containing beads, is believed to be due to the parallel-running channels 24. The ability to use fibers 20 of any desired length, while encountering relatively low backpressures, would suggest great potential for using columns 22 of these channeled polymer fibers 20 in prep-scale separations or for waste remediation in a variety of industries.

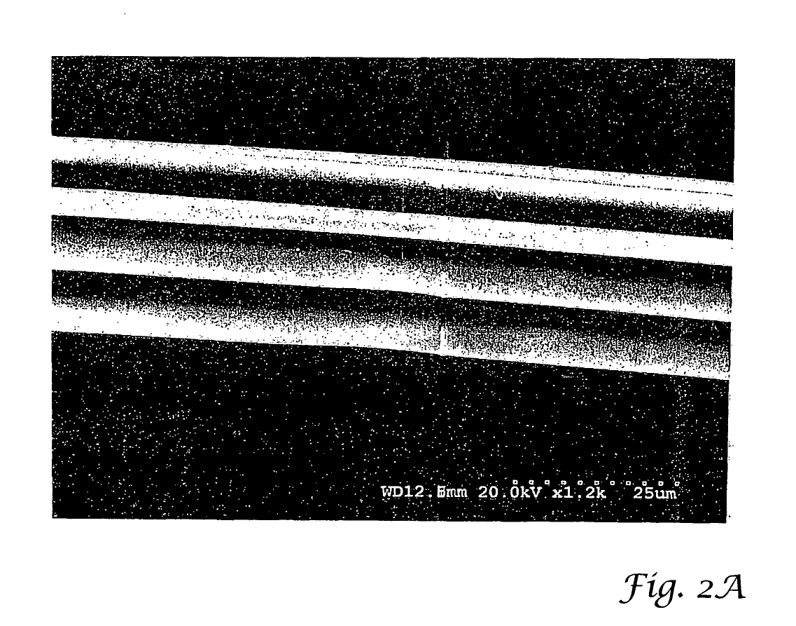

There are different fabrication approaches to form channeled polymer fibers 20 of the sort demonstrated here. In general, the process used to make these channeled, polymer fibers 20 is amenable to any polymers that can be spin-melted. For example, channeled fibers 20 may be melt spun from any of a number of different polymer precursors. A non-limiting list of exemplary materials from which the fibers of the invention can be formed can include polypropylene precursors, polyester precursors, polyaniline precursors, precursors composed of polylactic acid, and nylon precursors. Thus, FIG. 2A is a micrograph of an enlarged side view of an intermediate portion of a channeled polyester fiber useful in accordance with the present invention and FIG. 2B is a micrograph of enlarged side views of end portions of two channeled polyester fibers.

In general use, the present channeled polymer fibers 20 tend to have a very strong wicking action for a variety of liquids, including water. The separation and filtration capabilities of the present channeled polymer fibers are described in detail in the present parent, U.S. Ser. No. 10/485,701, filed Feb. 3, 2004, which is hereby incorporated by reference in its entirety.

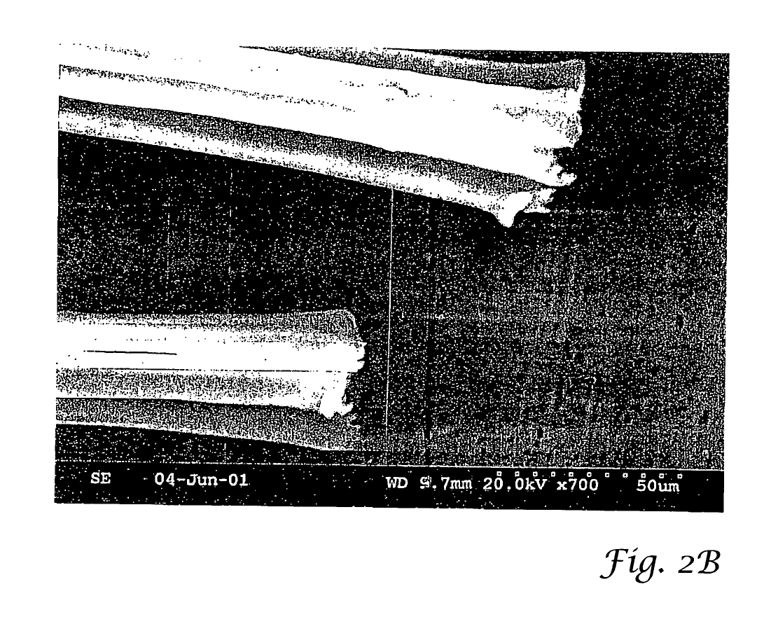

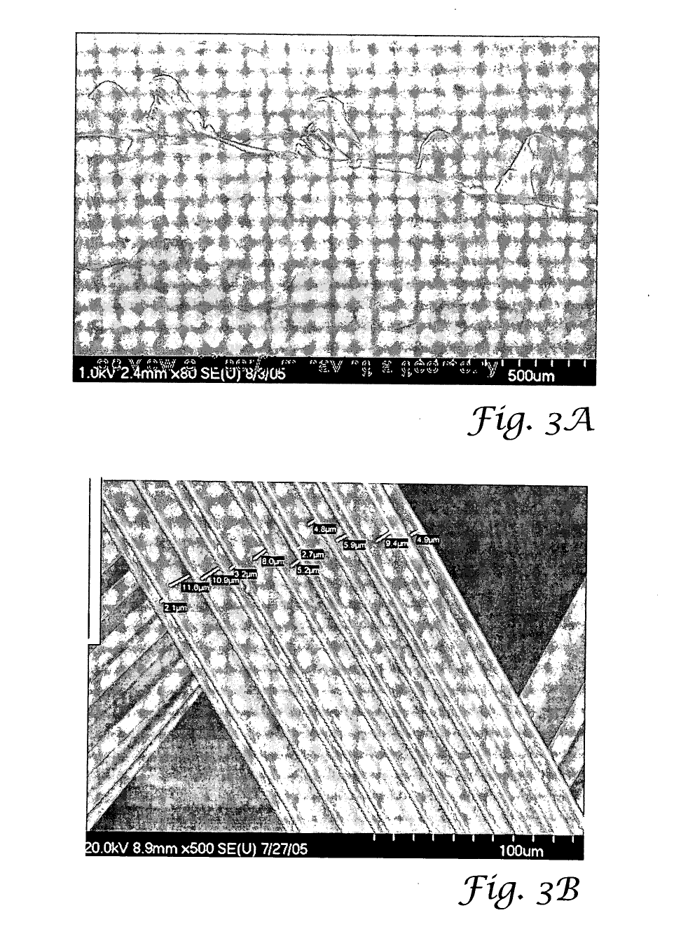

Additionally, although the present invention is directed generally to the use of surface-channeled “fibers,” it has also been found that surface channeled films may be employed in accordance with the present invention. Although a variety of definitions may be found which distinguish a fiber from a film, for purposes of the present application it should be noted that the present fibers, having an extended length in the longitudinal direction, generally have a first transverse direction dimension which is no more than about two or three times greater than a second, orthogonal transverse direction dimension. A film in accordance with the present invention has a transverse direction dimension, which is four or more times greater than the film width (i.e., the second transverse dimension). Thus, FIGS. 3A and 3B are micrographs of a cross-sectioned and a side view of a surface channeled film in accordance with the present invention. These films, which are extruded in a manner similar to the fibers but through an elongated die, are particularly suitable for certain applications of the present invention, as is discussed in more detail below. However, for most applications the present surface channeled films may be used interchangeably with the surface-channeled fibers. The term “fiber/film” as used herein denotes that either the present surface-channeled fiber or the present surface-channeled film may be employed.

Thus, in accordance with the present invention FIG. 4A schematically illustrates a simple separation apparatus containing a plurality of packed fibers, preferably surface channeled fibers as illustrated in FIG. 1. Specifically, fluid conduit 40 has a first end 42 associated with a fluid source 43 and a second, terminal end 44. Fibers 46 are disposed within the conduit, extending between the first end and the second end. A probing position 48 is defined on the conduit between the first and second ends. A spectroscopic detector 49, better illustrated in FIG. 4B, is aligned with the probing position and configured for detecting solute species in a fluid moving through the conduit and along the length of the polymer fibers. FIG. 4A schematically represents an incident photon 50 and a scattered, transmitted or fluorescent photon 52 of the detector 49 (not shown in FIG. 1).

It should be noted that although it is preferred that the fibers packed in conduit 40 are surface-channeled, fibers of other cross-sectional geometries may also be employed in accordance with the present invention as long as capillary channels are formed between the fibers. However, the presently described surface-channeled fibers are greatly preferred because of the increased surface area of the channels and the concomitant low backpressures associated with their use. Further, channeled fibers also allow for wicking ability on a single fiber basis. In some embodiments it may be preferable that at least a portion of the fibers are bonded to adjacent fibers.

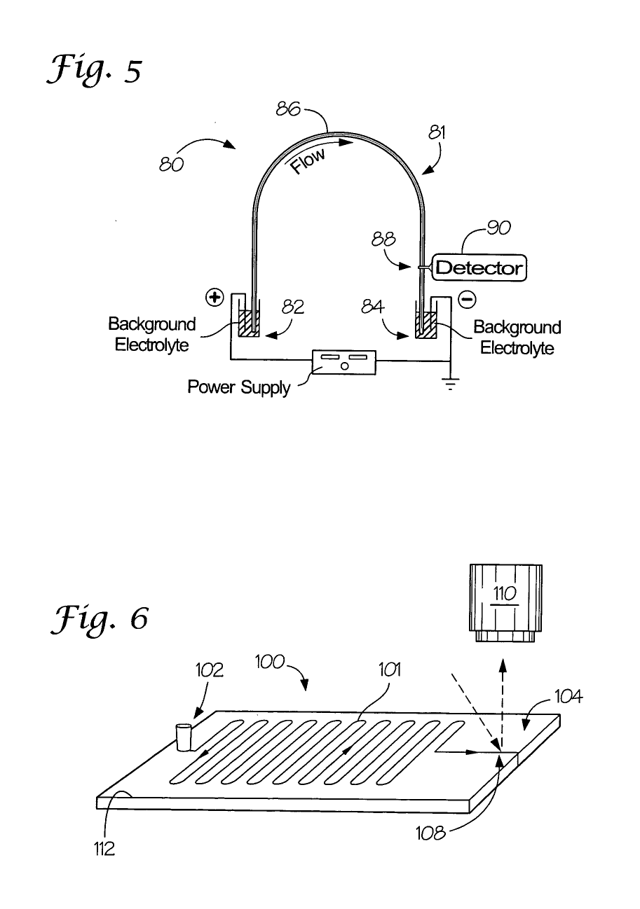

Thus, a fluid containing at least one solute species is moved through the capillaries defined by packed polymer fibers 46, the solute species is separated from the fluid by chemical or electrostatic interaction with the surface of the polymer fibers, and it is detected on the fibers with the spectroscopic detector. The fluid may be pumped through the conduit, such as by optional pump 54, it may move through the conduit by wicking action, or it may move through the conduit by some other means such as electro-osmosis. An example of the latter is discussed below with respect to FIG. 5. The composition of the polymer fibers may be such that they inherently attract and retain specific solute species or they may be modified, either to exhibit enhanced reactivity toward specific solute species or to exhibit attraction and binding for a specific solute species. Also, the surface may be modified to increase or lessen wicking action within the channels. Regardless, the species is detected on the fibers at probing position 48 by a detection method such as IR absorbance, UV-VIS absorbance, fluorescence, Raman spectroscopy, mass spectrometry or any other suitable method.

As noted above, one means for moving the fluid through a fluid conduit in accordance with the present invention is electro-osmosis. FIG. 5 schematically illustrates a capillary electrophoresis system 80 in which the capillary 81 is packed with fibers defining capillary channels. As was the case for the column discussed above, capillary 81 is a fluid conduit having a first end 82 and a second end 84. Fibers 86 are disposed within the conduit, extending between the first end and the second end. A probing position 88 is defined on the conduit between the first and second ends. A spectroscopic detector 90 is aligned with the probing position and configured for detecting solute species in a fluid moving through the conduit and along the length of the polymer fibers. However, in this system rather than relying merely on the wicking action of the fibers or an external pump, the fluid migrates under the influence of an electrostatic potential.

Although the two systems described above are directed to separation apparatus having capillaries defined by a plurality of packed fibers, preferably packed surface-channeled fibers, it should be noted that a single surface-channeled fiber as described herein may be employed as a separation column. One preferred use for such single fibers in accordance with the present invention is as an extraction probe for solid-phase extraction. In a further embodiment, single surface-channeled fibers are particularly suited for use in microfluidic devices known as “lab on a chip” devices. As is seen in FIG. 6, microfluidic device 100 includes a single surface-channeled fiber 101, which, in this embodiment, defines a fluid conduit having a first end 102 and a second end 104. A probing position 108 is defined along the fiber between the first and second ends. A spectroscopic detector 110 is aligned with the probing position and configured for detecting solute species in a fluid moving along the length of the polymer fiber. The fiber is mounted within a channel of a polymeric, silicon or glass chip 112 in a similar manner to that shown in FIG. 4B.

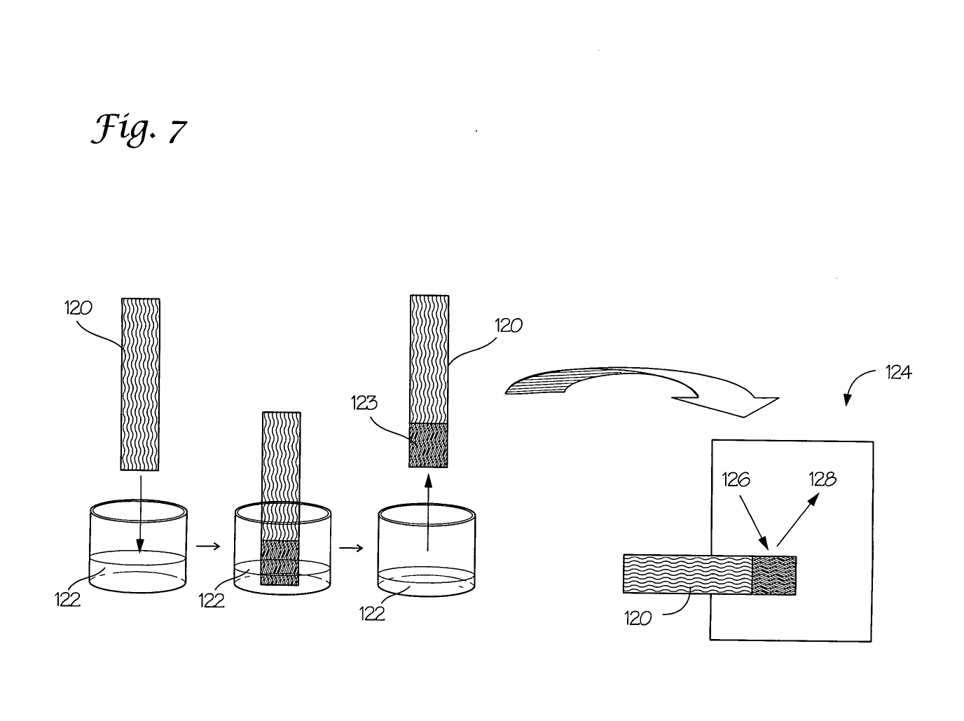

In addition to embodiments in which a detector is aligned with a probing position on a column, the present invention is also directed to systems in which one or more fibers as described herein are employed as a means to gather a fluid and take it to a detector. Thus, at least one polymer fiber as described here is exposed to a fluid such that the fluid wicks onto the fiber and the at least one fiber is then positioned in an instrument configured for detecting a solute species of interest. Specifically, FIG. 7 illustrates a plurality of fibers (or, alternatively, a single channeled film) in the form of a test strip 120 being exposed to a test solution 122 such that at least some of the solution wicks onto the fibers as is shown at 123. The test strip is then transported to an instrument 124 for on-column analysis using an appropriate probe beam and detector. For example, an incident photon 126 and a scattered, transmitted or fluorescent photon 128 are represented schematically. Alternatively, the probe beam may yield species suitable for analysis by mass spectrometry.

All of the above-described systems are directed to the use of one or more fibers as a stationary phase for the transport of fluid, with a spectroscopic detector employed for detecting at least one solute species on the surface of the fiber or fibers. However, also within the scope of the present invention are systems in which, as above, one or more fibers act as a stationary phase for the transport of fluid, but a spectroscopic detector is not employed for detecting the presence of species. Rather, the presence of at least one solute species is indicated by a visually detectable response. In essence, the user is the detector. Such systems are useful in a variety of end-use applications such as test strips and pregnancy tests, generically known as lateral flow assays.

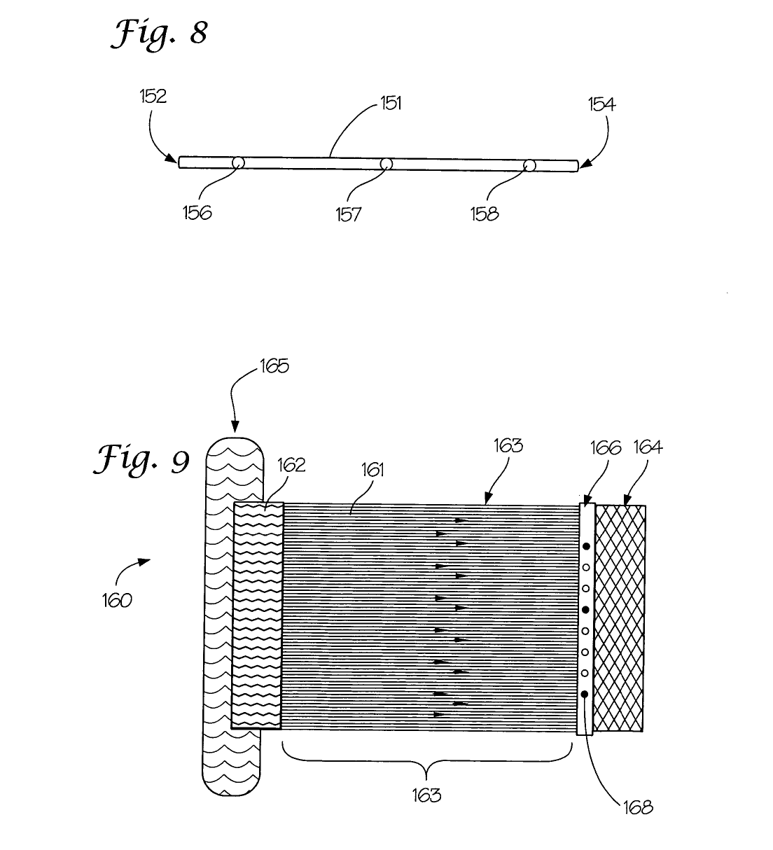

Thus, the fiber surface is modified by the presence of at least one chemically selective indicator. In the presence of the investigated solute species the chemically selective indicator produces a visually distinguishable response, most preferably a color change. For some applications it is preferable that only one chemically selective indicator is present to test for the presence of one particular solute species. For other applications two or more indicators are employed to test for the presence of at least two differing solute species. FIG. 8 illustrates a simple embodiment of this aspect of the present invention. Single surface-channeled fiber 151 defines a fluid conduit having a first end 152 and a second end 154. The fiber surface has been modified to have a first chemically selective indicator 156, a second chemically selective indicator 157, and a third chemically selective indicator 158. In this embodiment the three indicators are spaced from each other along the length of the fiber. At least for the single fiber system, such spacing is preferred. Thus, a fluid moves along the fiber from the first end 152 to the second end 154; the presence of a possible first solute species is indicated by a visually distinguishable response of the first indicator 156, the presence of a possible second solute species is indicated by a visually distinguishable response of the second indicator 157, and the presence of a possible third solute species is indicated by a visually distinguishable response of the third indicator 158. The absence of any one of these species is confirmed by the absence of the respective response.

Of greater versatility are systems which employ a plurality of fibers in accordance with the present invention. FIG. 9 illustrates the use of the present surface-channeled fibers in a lateral flow assay 160. Rather than being packed, in this embodiment a series of fibers 161 are aligned on an underlying film 163 in an ordered array. The first end 162 of the fiber/film composite defines a collection region. The first end is exposed to a solvent reservoir 165 and the fluid flows along the fibers to the second end 164. Between the first end and the second end a detector array 166 is defined. In most applications, collection region 162 is dipped into, or passed through, the sample-containing stream. Solvent reservoir 165 is provided for the case where the sample is pre-immobilized and must be transported down the fiber structure by a second mobile phase fluid. Different from what is shown in FIG. 8, eight chemically selective indicators 168 are present in adjacent alignment. In this illustration, of the eight species for which the fluid is being tested, three, those indicated by the first, fourth and bottom indicators, are present. As an alternative to the fiber/film composite of FIG. 9, a surface-channeled film in accordance with the present invention, such as is described above and shown in the scanning electron micrographs of FIGS. 3A and 3B, may be employed in a variety of lateral flow assay applications.

Of course, also within the scope of the present invention are systems in which two or more chemically selective indicators are present along the length of a plurality of fibers in a spaced, rather than adjacent, configuration. Furthermore, systems in which only one chemically selective indicator is present along the length of a plurality of fibers or at least one channeled film are useful in a variety of end-use applications such as pregnancy or ovulation tests.

Preferred embodiments of the invention have been described using specific terms and devices. The words and terms used are for illustrative purposes only. The words and terms are words and terms of description, rather than of limitation. It is to be understood that changes and variations may be made by those of ordinary skill art without departing from the spirit or scope of the invention, which is set forth in the following claims. In addition it should be understood that aspects of the various embodiments may be interchanged in whole or in part. Therefore, the spirit and scope of the appended claims should not be limited to descriptions and examples herein.

What is claimed is:

1. An apparatus, comprising:
a fluid conduit having a first end and a second end disposed opposite the first end;
a plurality of polymer fibers disposed within the conduit, extending between the first end and the second end;
a probing position defined at a location on the conduit between the first end and the second end of the conduit; and
a spectroscopic detector in alignment with the probing position and configured for detecting solute species in a fluid moving through the conduit and along the length of the polymer fibers.

2. An apparatus as set forth in claim 1 wherein each of the polymer fibers is configured with a plurality of co-linear channels along the entire length of the surface of each fiber.

3. An apparatus as set forth in claim 1 further comprising a device for moving fluid through the conduit, the device being connected to the first end of the conduit.

4. An apparatus as set forth in claim 1 wherein the polymeric composition of the polymer fibers inherently attracts and retains specific solute species.

5. An apparatus as set forth in claim 1 wherein the polymer fibers have been modified to exhibit enhanced reactivity toward specific solute species.

6. An apparatus as set forth in claim 1 wherein the polymer fibers have been modified to exhibit attraction and binding for a specific solute species.

7. An apparatus, comprising:
a fluid conduit having a first end and a second end disposed opposite the first end;
a polymer fiber/film disposed within the conduit, extending between the first end and the second end, the fiber having a plurality of co-linear channels along the entire length of the surface thereof;
a probing position defined at a location along the conduit between the first end and the second end of the conduit; and
a spectroscopic detector in alignment with the probing position and configured for detecting solute species in a fluid moving through the conduit and along the length of the polymer fiber/film.

8. An apparatus as set forth in claim 7 further comprising a device for moving fluid through the conduit, the device being connected to the first end of the conduit.

9. An apparatus as set forth in claim 7 wherein the polymeric composition of the polymer fiber/film inherently attracts and retains specific solute species.

10. An apparatus as set forth in claim 7 wherein the polymer fiber/film has been modified to exhibit enhanced reactivity toward specific solute species.

11. An apparatus as set forth in claim 7 wherein the polymer fiber/film has been modified to exhibit attraction and binding for a specific solute species.

12. A method for detecting at least one solute species in a fluid, comprising:
providing a fluid conduit having a first end and a second end disposed opposite the first end, the conduit having at least one polymer fiber/film disposed therein, the at least one polymer fiber/film defining a plurality of capillary channels capable of wicking a fluid;
defining a probing positioning at a location along the conduit between the first end and the second end of the conduit;
aligning an instrument with the probing position, the instrument being configured for detecting the at least one solute species;
moving fluid containing the at least one solute species through the capillaries;
separating the at least one species from the fluid by chemical or electrostatic interaction of the species with the at least one polymer fiber/film; and
detecting the at least one species on the at least one polymer fiber/film with the instrument.

13. The method of claim 12, wherein the fluid is pumped through the capillary channels.

14. The method of claim 12, wherein the fluid is moved through the capillary channels by wicking action.

15. The method of claim 12, wherein the fluid is moved through the capillary channels via electro-osmosis.

16. The method of claim 12, wherein the conduit has a single polymer fiber/film positioned therein, the capillary channels being formed by a plurality of co-linear channels configured along the entire length of the surface of the polymer fiber/film.

17. The method of claim 12, wherein the conduit has a plurality of polymer fibers aligned therein.

18. The method of claim 17 wherein each of the polymer fibers is configured with a plurality of co-linear channels along the entire length of the surface of each fiber.

19. The method of claim 17 wherein at least a portion of the fibers are bonded to adjacent fibers.

20. The method of claim 12, wherein the step of detecting the at least one species is achieved by a detection method selected from the group consisting of IR absorbance, UV-VIS absorbance, fluorescence, Raman spectroscopy, and mass spectrometry.

21. A device for visually detecting at least one solute species in a fluid, comprising:
at least one polymer fiber/film, the at least one polymer fiber/film defining a plurality of capillary channels capable of wicking a fluid; and
at least one chemically selective indicator disposed on the surface of the at least one polymer fiber/film, the chemically selective indicator exhibiting a visually distinguishable response in the presence of the at least one solute species.

22. The device set forth in claim 21 wherein the at least one polymer fiber/film comprises a single polymer fiber/film, the capillary channels being formed by a plurality of co-linear channels configured along the entire length of the surface of the polymer fiber/film.

23. The device set forth in claim 21 wherein the at least one polymer fiber/film comprises a plurality of polymer fibers.

24. The device set forth in claim 23 wherein at least a portion of the plurality of polymer fibers are bonded to adjacent fibers.

25. The device set forth in claim 23 wherein each of the polymer fibers is configured with a plurality of co-linear channels along the entire length of the surface thereof.

26. The device set forth in claim 21 wherein the at least one chemically selective indicator comprises at least a first chemically selective indicator and a second chemically selective indicator for detecting at least two differing solute species.

27. The device set forth in claim 26 wherein the first chemically selective indicator is disposed on the surface of the at least one polymer fiber/film at a desired interval from the disposition of the second chemically selective indicator.

28. The device set forth in claim 26 wherein the first chemically selective indicator and the second chemically selective indicator are essentially adjacent to each other and are at essentially the same position along the length of the at least one polymer fiber/film.

29. A method for detecting at least one solute species in a fluid, comprising:
providing at least one polymer fiber/film having a first end and a second, the at least one polymer fiber/film defining a plurality of capillary channels capable of wicking a fluid;
disposing on the surface of the at least one polymer fiber at least one chemically selective indicator, the chemically selective indicator being capable of exhibiting a visually distinguishable response in the presence of the at least one solute species; exposing the first end of the at least one polymer fiber/film to a fluid; and
observing the at least one polymer fiber/film to determine the presence of a visually distinguishable response indicating the presence of the at least one solute species.

30. The method set forth in claim 29 wherein the at least one polymer fiber/film comprises a single polymer fiber/film, the capillary channels being formed by a plurality of co-linear channels configured along the entire length of the surface of the polymer fiber/film.

31. The method set forth in claim 29 wherein the at least one polymer fiber/film comprises a plurality of polymer fibers.

32. The method set forth in claim 31 wherein at least a portion of the plurality of polymer fibers are bonded to adjacent fibers.

33. The method set forth in claim 31 wherein each of the polymer fibers is configured with a plurality of co-linear channels along the entire length of the surface thereof.

34. The method set forth in claim 29 wherein the visually distinguishable response exhibited by the chemically selective indicator comprises a color change.

35. The method set forth in claim 29 wherein the at least one chemically selective indicator comprises at least a first chemically selective indicator and a second chemically selective indicator for detecting at least two differing solute species.

36. The method set forth in claim 35 wherein the step of disposing at least one chemically selective indicator on the surface of the at least one polymer fiber/film comprises disposing the first chemically selective indicator on the surface of the at least one polymer fiber/film and disposing the second chemically selective indicator on the surface of the at least one polymer fiber/film at a desired interval from the first chemically selective indicator.

37. The method set forth in claim 35 wherein the step of disposing at least one chemically selective indicator on the surface of the at least one polymer fiber/film comprises disposing the first chemically selective indicator and the second chemically selective indicator essentially adjacent to each other and at essentially the same position along the length of the at least one polymer fiber/film.

38. A method for detecting at least one solute species in a fluid, comprising:
providing at least one polymer fiber/film having a first end and a second, the at least one polymer fiber/film defining a plurality of capillary channels capable of wicking a fluid;
exposing the first end of the at least one polymer fiber/film to a fluid containing the at least one solute species such that the fluid wicks onto the at least one polymer fiber/film;
separating the at least one species from the fluid by chemical attachment of the species to the at least one polymer fiber/film;
positioning the at least one polymer fiber/film in an instrument configured for detecting the at least one solute species; and
detecting the at least one species on the at least one polymer fiber/film with the instrument.

39. The method of claim 38, wherein the step of detecting the at least one species is achieved by a detection method selected from the group consisting of IR absorbance, UV-VIS absorbance, fluorescence, Raman spectroscopy, and mass spectrometry.
